(19) United States
(12) Patent Application Publication
(10) Pub. No.: US 2023/0373227 A1
(43) Pub. Date: Nov. 23, 2023

(54) PRINTING DEVICE

(71) Applicant: ALTEMIRA Co., Ltd., TOKYO (JP)

(72) Inventor: Shinichi OJIMA, Bunkyo-ku, Tokyo (JP)

(73) Assignee: ALTEMIRA Co., Ltd., TOKYO (JP)

(21) Appl. No.: 18/024,970

(22) PCT Filed: Sep. 14, 2021
(86) PCT No.: PCT/JP2021/033711

§ 371 Date: Mar. 7, 2023

(30) Foreign Application Priority Data
Oct. 12, 2020 (JP) 2020-172083

(51) Int. Cl. B41J 3/407; B41J 11/00

(52) U.S. Cl. CPC B41J 3/40733; B41J 3/40731; B41J 11/00214; B41J 11/00218

(57) ABSTRACT

When each of can bodies 10 moves, the can body 10 is not located at a stop point 40, and ultraviolet light from a light source 13 is going to proceed toward a printing part 120 as indicated by an arrow 3A. On this occasion, a shielding part 51 becomes located at a position facing the light source 13, and thereby, the ultraviolet light is shielded to be less likely to reach the printing part 120.

### TECHNICAL FIELD

The present invention relates to a printing device.

### BACKGROUND ART

Patent Document 1 discloses a surface processing device including a predetermined number of processing stations that perform processing processes and a conveying unit that performs a processing operation, in which a rotationally symmetrical object is conveyed by the conveying unit to a desired fixed position of the processing station.

### CITATION LIST

### Patent Literature

Patent Document 1: Japanese Patent No. 4615999

### SUMMARY OF INVENTION

### Technical Problem

In a printing apparatus performing printing on can bodies, a printing unit that performs printing on can bodies, and a curing unit for curing images formed on the can bodies are provided in some cases.

The curing unit uses light, heat, etc. to cure the images, however, there is a risk of deteriorating the quality of the image formed when the light or heat acts on the printing unit.

An object of the present invention is to suppress deterioration of quality of an image formed on a can body caused by a curing unit that cures the image formed on the can body.

### Solution to Problem

Under the above object, a printing device to which the present invention is applied includes: a can body moving unit moving a can body and stopping the can body at a stop point; a printing part performing printing on the can body located at the stop point to form a print image on the can body; a curing unit disposed on a side opposite to a side on which the printing part is installed across a can body moving route, which is a moving route of the can body, the curing unit emitting light or heat to the can body located on the stop point to cure the print image formed on the can body; and a shielding part located between the curing unit and the printing part, when the can body is not located at the stop point, to shield light or heat proceeding from the curing unit toward the printing part.

Here, when the can body is not located at the stop point, the shielding part may be located at a point facing at least one it may be possible to the curing unit and the printing part, and, when the can body is located at the stop point, the shielding part may be located at a point deviated from the facing point.

In addition, the can body moving unit may move the can body to move around a predetermined center, and the curing unit may be disposed closer to the center than the can body moving route through which the moving can body passes.

In addition, the shielding part may be disposed closer to the center than the can body moving route.

In addition, the can body moving unit may move the can body to move around a predetermined center, and the shielding part may be configured with part of an annular member formed into an annular shape and rotating around a point where the center is positioned as a rotation center.

Moreover, the can body moving unit may move the can body to move around a predetermined center, the shielding part may be configured with part of an annular member formed into an annular shape and rotating around a point where the center is positioned as a rotation center, the annular member may be provided with a passing part for passing the heat or the light proceeding from the curing unit toward the can body, and, when the can body is located at the stop point, the passing part of the annular member may be located between the curing unit and the can body to allow light or heat from the curing unit to pass through the passing part and proceed toward the can body.

In addition, the annular member may rotate while keeping a state in which the passing part provided in the annular member is located at a position facing the can body.

In addition, the passing part of the annular member may be provided with at least one of a lens passing light proceeding from the curing unit toward the can body and/or a reflection member reflecting light from the curing unit toward the can body.

In addition, when the can body is not located at the stop point, the passing part of the annular member may be located at a point deviated from between the curing unit and the printing part, and a restriction part may be further provided to restrict light or heat from the curing unit that passes the passing part located at the deviated point and proceeds toward a side opposite to a side on which the curing unit is provided.

In addition, the restriction part may be configured with part of an annular-shaped member disposed coaxially with the annular member.

In addition, the annular-shaped member may be provided with a passing part for passing the heat or the light proceeding from the curing unit toward the can body located at the stop point.

In addition, a gap may be formed between the annular member and the annular- shaped member disposed coaxially with the annular member, and gas generated from the print image due to heat applied to the print image may pass through the gap, and may be discharged to outside of the printing device.

### Advantageous Effects of Invention

According to the present invention, it is possible to suppress deterioration of quality of the image formed on a can body caused by a curing unit that cures the image formed on the can body.

### BRIEF DESCRIPTION OF DRAWINGS

FIG. 1 is a side elevational view of a printing device;

FIG. 2 is a cross-sectional view of the printing device along the II-II line in FIG. 1;

FIG. 3 is a diagram showing a state of the printing device when a can body is moving;

FIG. 4 is a diagram showing another configuration example of the printing device;

FIG. 5 is a diagram showing another configuration example of the printing device;

FIG. 6 is a diagram showing another configuration example of the printing device; and

FIG. 7 is a diagram showing another configuration example of the printing device.

### DESCRIPTION OF EMBODIMENT

Hereinafter, an exemplary embodiment according to the present invention will be described with reference to attached drawings.

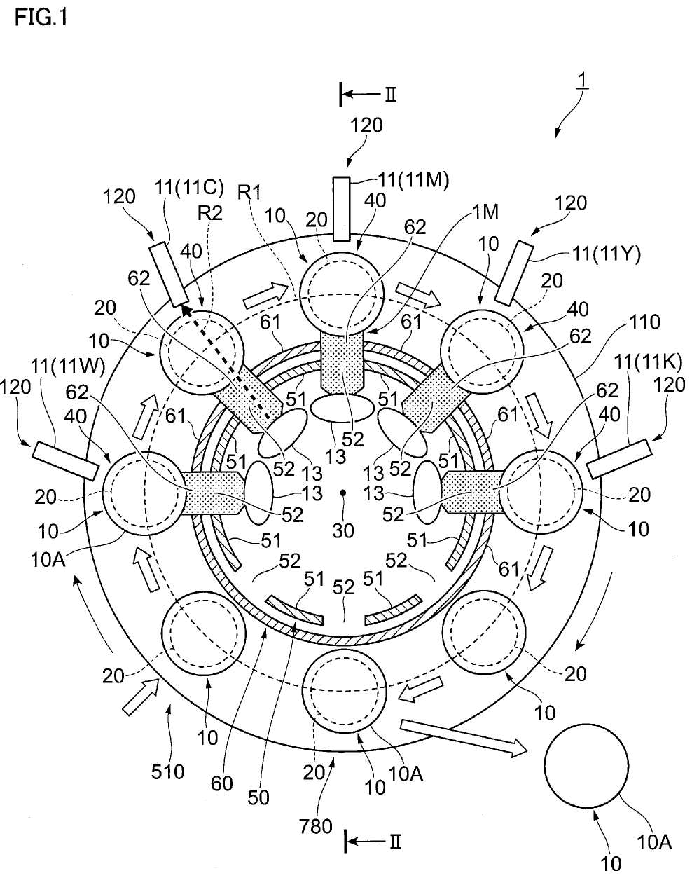

FIG. 1 is a side elevational view of a printing device 1.

The printing device 1 is provided with a can body supply part 510 to which can bodies 10 are supplied. In the can body supply part 510, the can body 10 is attached (supplied) to a support member 20 supporting the can body 10.

Specifically, the support member 20 is formed into a cylindrical shape and is inserted into the cylindrically-shaped can body 10; thereby the can body 10 is attached to the support member 20.

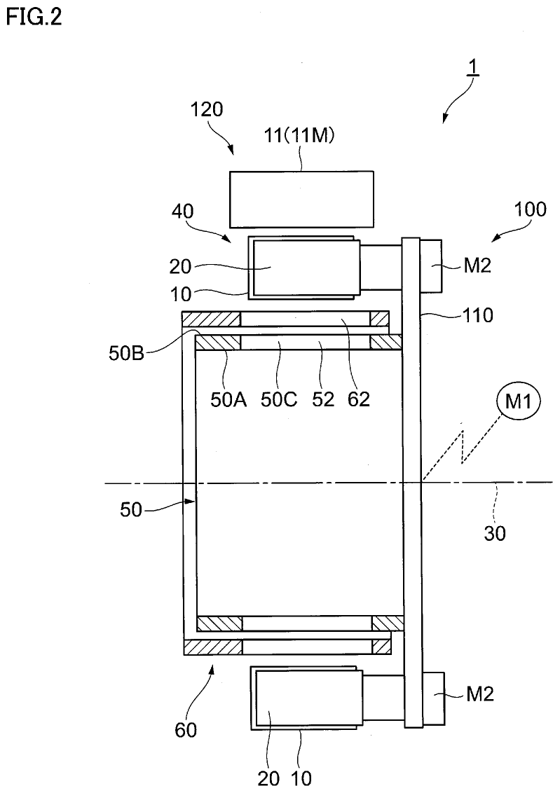

FIG. 2 is a cross-sectional view of the printing device 1 along the II-II line in FIG. 1. Note that, in FIG. 2, illustration of part of members shown in FIG. 1 is omitted.

In the exemplary embodiment, a can body moving mechanism 100 as an example of a can body moving unit that moves the can body 10 is provided on the backside of the printing device 1.

The can body moving mechanism 100 moves the can body 10 so that the can body 10 is moved around a predetermined center 30 (hereinafter, simply referred to as “center 30”) (refer to FIG. 1). In addition, the can body moving mechanism 100 stops the can body 10 at each of plural stop points 40 (refer to FIG. 1).

In the exemplary embodiment, as the can body moving mechanism 100, a circular-disk-shaped rotation member 110 rotating around the center 30 as the rotation center is provided as shown in FIGS. 1 and 2.

In the exemplary embodiment, as shown in FIG. 2, plural support members 20 (the can bodies 10) are supported by the rotation member 110.

As shown in FIG. 1, the plural support members 20 (the can bodies 10) are disposed in the state of being arranged in the circumferential direction of the rotation member 110.

In addition, as shown in FIG. 2, the can body moving mechanism 100 is provided with a first motor M1 that rotates the rotation member 110.

Further, in the exemplary embodiment, as shown in FIG. 2, a second motor M2 is provided to correspond to each of the support members 20 to rotate the support member 20 (the can body 10) in the circumferential direction.

In the exemplary embodiment, the rotation control of the first motor M1 is performed by a not-shown controller to rotate the rotation member 110 intermittently. In the exemplary embodiment, the rotation member 110 rotates intermittently; accordingly, movement of the can body 10 and a stop of the can body 10 at the stop point 40 are performed repeatedly.

In the exemplary embodiment, rotation of the rotation member 110 moves the can body 10 (the support member 20) along a predetermined annular route R (hereinafter, sometimes referred to as “can body moving route R1”) (see FIG. 1).

In other words, in the exemplary embodiment, rotation of the rotation member 110 moves the can body 10 around the center 30.

Here, in the exemplary embodiment, “the can body 10 moves along the annular route” does not mean that the can body 10 moves along all over the annular route, but means that the can body 10 moves along part of the annular route.

With reference to FIG. 1, the printing device 1 will be further described.

In the exemplary embodiment, on the downstream side of the can body supply part 510, plural printing parts 120 are provided.

Each of the printing parts 120 is provided to correspond to each stop point 40, and performs printing on the can body 10 located at the stop point 40. Consequently, in the exemplary embodiment, a print image is formed on the outer circumferential surface 10A of the can body 10.

Here, each of the printing parts 120 in the exemplary embodiment is configured with the so-called inkjet heads 11, and the print image is formed on the can body 10, which is located at the stop point 40 and rotating in the circumferential direction, using the inkjet printing method.

Note that, in the exemplary embodiment, there are provided an inkjet head 11W that ejects white ink, an inkjet head 11C that ejects cyan ink, an inkjet head 11M that ejects magenta ink, an inkjet head 11Y that ejects yellow ink, and an inkjet head 11K that ejects black ink, as the inkjet heads 11.

Here, the five inkjet heads 11, namely, the inkjet heads 11W to 11K perform image formation on the can body 10 using ultraviolet cure ink.

In other words, the five inkjet heads 11 perform image formation onto the can body 10 by using photo-curable ink, which cures upon being irradiated with light such as ultraviolet rays.

Here, the image formation by the inkjet printing method refers to image formation performed by ejecting ink from the inkjet heads 11 to attach the ink to the can body 10.

In the image formation by the inkjet printing method, publicly known systems can be used. Specifically, for example, the piezo system, the thermal (bubble) system, or the continuous system can be used.

Note that the colors of ink ejected by the inkjet heads 11 are not limited to the above five colors, and ink of other colors may be ejected from the inkjet heads 11.

In addition, transparent ink may be ejected from the inkjet heads 11, not limited to colored ink.

Moreover, in the exemplary embodiment, the case in which the five inkjet heads 11 are provided is described as an example; however, the number of inkjet heads 11 to be installed is not particularly limited, and the inkjet heads 11 in the number other than five may be provided.

Further, in the exemplary embodiment, as shown in FIG. 1, plural light sources 13, as an example of curing unit, that cure the print images formed on the can bodies 10 are provided.

The light source 13 is provided to correspond to each of the plural stop points 40. In addition, the light sources 13 are located on the side opposite to the side where the printing parts 120 are installed across the can body moving route R1.

The light source 13 emits light of the wavelength in the ultraviolet range (hereinafter, referred to as “ultraviolet light” in some cases), as an example of light, to the can body 10 which is stopped at the stop point 40 and is rotating in the circumferential direction. This cures the print image formed on the outer circumferential surface 10A of the can body 10.

In addition, in the exemplary embodiment, plural shielding parts 51 that shield ultraviolet light from the respective light sources 13 are provided as shown in FIG. 1.

As will be described later, in the exemplary embodiment, in the case where the can body 10 is not located at the stop point 40, the shielding part 51 is located at the position facing the light source 13.

More specifically, in the exemplary embodiment, in the case where the can body 10 is not located at the stop point 40, the shielding part 51 is located on a route R2, through which ultraviolet light from the light source 13 to proceed toward the printing part 120 passes.

Consequently, in the exemplary embodiment, it becomes difficult for the light emitted from the light source 13 to reach the printing part 120 (details will be described later).

In the exemplary embodiment, a first annular member 50 (also refer to FIG. 2) is provided inside the can body moving route R1. The first annular member 50 is formed into an annular shape, and rotates around a point where the center 30 (refer to FIG. 1) is located as a rotation center.

More specifically, the first annular member 50 is disposed coaxially with the rotation member 110, and rotates around the point where the center 30 is located.

In addition, in the exemplary embodiment, the first annular member 50 is attached to the rotation member 110, and rotates in conjunction with the rotation member 110, as shown in FIG. 2.

In the exemplary embodiment, each of the plural shielding parts 51 (refer to FIG. 1) is configured with part of the first annular member 50.

Further, as shown in FIGS. 1 and 2, the first annular member 50 is provided with passing parts 52 through which light from the light sources 13 toward the can bodies 10 stopping at the stop points 40 passes. In other words, the first annular member 50 is provided with the passing parts 52 for passing the light from the light sources 13 toward the can bodies 10 stopping at the stop points 40.

As shown in FIG. 2, the passing part 52 is configured with a through hole 50C that connects the inner circumferential surface 50A side and the outer circumferential surface 50B side of the first annular member 50.

Note that the passing part 52 is not limited to the through hole 50C, but may be formed in other shapes such as a cutout.

In the exemplary embodiment, in the case where the can body 10 is located at each of the stop points 40, the passing part 52 provided in the first annular member 50 is located between the light source 13 and the can body 10, as shown in FIG. 1. This allows light from the light source 13 to pass through the passing part 52 and proceed toward the can body 10.

In this case, the print image formed on the can body 10 is irradiated with ultraviolet light to be cured.

As shown in FIG. 1, in the exemplary embodiment, each of the light sources 13 is disposed closer to the center 30 than the can body moving route R1. In addition, in the exemplary embodiment, the first annular member 50 (the shielding part 51) is also disposed closer to the center 30 than the can body moving route R1.

Here, disposition of the light source 13 closer to the center 30 than the can body moving route R1 makes it easier to reduce the light sources 13.

In the case where the light source 13 is disposed closer to the center 30 than the can body moving route R1, for example, installation of a common light source 13 at the central 30 makes it possible to irradiate each of the plural stop points 40 with ultraviolet light.

More specifically, in the exemplary embodiment shown in FIG. 1, the case in which the light sources 13 are provided as many as the number of stop points 40 is shown as an example; however, in the case in which the light sources 13 are disposed closer to the center 30 than the can body moving route R1, it is possible to share the light sources 13.

More specifically, in the case where the light sources 13 are disposed closer to the center 30 than the can body moving route R1, the light sources 13 of the number smaller than the number of stop points 40 are installed, and the can body 10 at each of the stop points 40 can be irradiated with ultraviolet light by the small number of light sources 13.

In addition, as shown in FIG. 1, in the exemplary embodiment, there are provided plural restriction parts 61 that restrict the ultraviolet light from the light sources 13 passing through the passing parts 52 and proceeding toward a side opposite to the side where the light sources 13 are installed.

The restriction part 61 is configured with part of a second annular member 60 disposed coaxially with the first annular member 50.

The second annular member 60 is formed into an annular shape. In addition, the second annular member 60 is not fixed to the rotation member 110 (refer to FIG. 2), but is fixed to the main body side of the printing device 1.

Note that the details of restriction on the ultraviolet light by the restriction part 61 will be described later.

As shown in FIGS. 1 and 2, the second annular member 60 is also provided with passing parts 62 through which light from the light sources 13 passes to proceed toward the can bodies 10 stopping at the stop points 40. In other words, the second annular member 60 is also provided with the passing parts 62 for directing the light from the light sources 13 toward the can bodies 10 stopping at the stop points 40.

The passing part 62 is, similar to the passing part 52 provided in the first annular member 50, configured with a through hole. Note that the passing part 62 is not limited to the through hole, but may be configured with a cutout, etc.

Further, as shown in FIG. 1, in the exemplary embodiment, a detachment part 780 that detaches the can body 10 from the support member 20 is provided on the downstream side of the plural printing parts 120.

In the exemplary embodiment, the can body 10 is detached from the support member 20 in the detachment part 780 to be discharged to the outside of the printing device 1.

Note that the can body 10 discharged to the outside of the printing device 1 is conveyed sequentially to the coating process in which transparent paint is applied to the outer circumferential surface 10A of the can body 10, and to the heating process in which the can body 10 coated with the transparent paint is heated.

Application of the transparent paint to the outer circumferential surface 10A of the can body 10 forms a protection layer on the outermost layer of the can body 10. In addition, heating of the can body 10 in the heating process cures the protection layer.

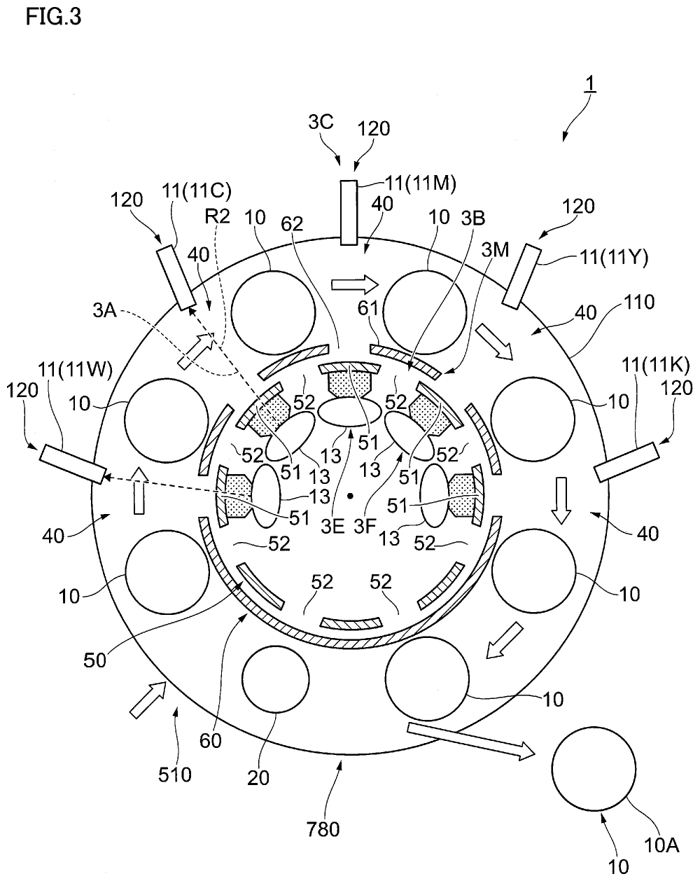

FIG. 3 is a diagram showing a state of the printing device 1 when the can body 10 is moving. More specifically, FIG. 3 is a diagram showing the state of the printing device 1 in which each can body 10 stopped at the stop point 40 is moving toward the next stop point 40 located on the downstream side.

In the exemplary embodiment, the first annular member 50 is attached to the rotation member 110, and rotates in conjunction with the rotation member 110. Consequently, in the exemplary embodiment, the first annular member 50 moves synchronously with the moving plural can bodies 10.

As a result, in the exemplary embodiment, the first annular member 50 rotates in the state where the passing parts 52 are located at the positions facing the can bodies 10, as shown in FIG. 3.

In addition, when each of the can bodies 10 moves and the first annular member 50 rotates, each of the shielding parts 51 provided in the first annular member 50 comes to be located at the position facing the light source 13.

In the exemplary embodiment, when each of the can bodies 10 moves, the can body 10 is not located at the stop point 40 as shown in FIG. 3, and the ultraviolet light from the light source 13 is going to proceed toward the printing part 120.

On this occasion, in the exemplary embodiment, the shielding part 51 is located at the position facing the light source 13, and accordingly, the ultraviolet light is shielded to be less likely to reach the printing part 120. In other words, the shielding part 51 is located between the light source 13 and the printing part 120, and thereby the ultraviolet light from the light source 13 to the printing part 120 is shielded.

To describe further, in the exemplary embodiment, in the state in which the can body 10 is not located at the stop point 40, the shielding part 51 is located on the route R2, through which the ultraviolet light from the light source 13 proceeding toward the printing part 120 passes.

Consequently, in the exemplary embodiment, the ultraviolet light is shielded, and it becomes difficult for the ultraviolet light to reach the printing part 120.

In the exemplary embodiment, in the case where the can body 10 is located at each of the stop points 40, the shielding part 51 is located at the position deviated from the position facing the light source 13, and the passing part 52 is located at the position facing the light source 13, as shown in FIG. 1. This makes it possible to irradiate the can body 10 with the ultraviolet light from the light source 13.

On the other hand, in the exemplary embodiment, in the state in which the can body 10 is not located at the stop point 40, the shielding part 51 is located at the position facing the light source 13, and accordingly, the ultraviolet light from the light source 13 does not proceed toward the printing part 120.

In addition, in the exemplary embodiment, as shown in FIG. 3, in the state in which the can body 10 is not located at the stop point 40, as indicated by the reference sign 3B, the passing part 52 of the first annular member 50 is located at the point deviated from between the light source 13 and the printing part 120 indicated by the reference sign 3C.

In this case, the light from the light sources 13 indicated by the reference signs 3E and 3F passes through the passing part 52 located at the deviated point and is going to proceed toward a side opposite to the side where the light source 13 is installed.

In contrast thereto, in the exemplary embodiment, the restriction part 61 (the restriction part 61 indicated by the reference sign 3M) configured with the second annular member 60 is located at the position facing the passing part 52, and thereby the light from the light source 13, which passes the passing part 52 and proceeds toward the side opposite to the side where the light source 13 is installed, is restricted.

In other words, the light from the light source 13 is restricted from passing through the passing part 52 and going outward in the radial direction of the first annular member 50.

Note that, in the exemplary embodiment, as indicated by the reference sign 1M in FIG. 1, the passing part 62 is provided at the portion of the second annular member 60, which is located at the position facing the stop point 40.

Consequently, in the exemplary embodiment, the ultraviolet light from the light source 13 proceeding toward the can body 10 located at the stop point 40 is prevented from being shielded by the second annular member 60.

In the exemplary embodiment, the second annular member 60 is provided with the passing part 62 while being provided with the restriction part 61; therefore, in the exemplary embodiment, it is possible to irradiate the can body 10 with the ultraviolet light while shielding the ultraviolet light passing through the passing part 52.

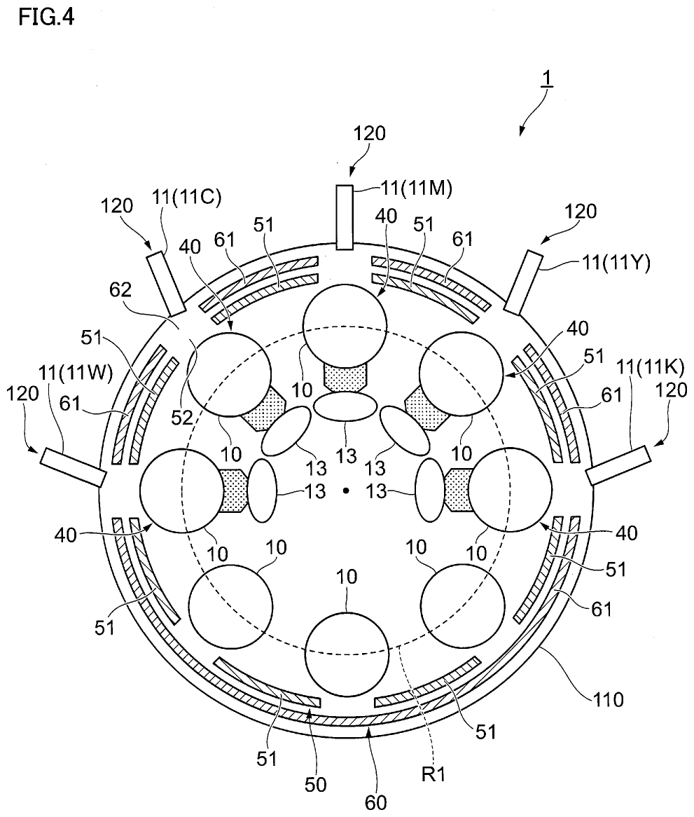

FIG. 4 is a diagram showing another configuration example of the printing device 1.

In the above, the configuration in which the shielding part 51 is located at the position facing the light source 13 is described; however, the configuration is not limited thereto, and a configuration in which the shielding part 51 is located at a position facing the printing part 120 may be available.

In this configuration example, the first annular member 50 and the second annular member 60 are provided outside the can body moving route R1. In addition, in the configuration example, similar to the above, the shielding parts 51 are configured with the first annular member 50.

In this configuration example, when the can body 10 is located at a point deviated from the stop point 40, the shielding part 51 is located at the position facing the printing part 120, to thereby prevent the ultraviolet light from the light source 13 from reaching the printing part 120.

In addition, in this configuration example, in the case where the passing part 52 is located at a position deviated from between the printing part 120 and the light source 13, the restriction part 61 configured with the second annular member 60 is located at the position facing the passing part 52. This prevents the light from the light sources 13 from passing through the passing part 52 and proceeding toward a side opposite to the side where the light source 13 is installed.

Note that, though the illustration is omitted, in the case where the first annular members 50 are provided both inside and outside the can body moving route R1 and the can body 10 is located at the points deviated from the stop points 40, the shielding parts 51 may be located both the positions facing the light sources 13 and the positions facing the printing parts 120.

Note that, in the case where the first annular members 50 are provided both inside and outside the can body moving route R1, the second annular members 60 may be provided both inside and outside the can body moving route R1, or may be provided only on one of the inside and the outside.

Note that, more preferably, in the case where the first annular member 50 is provided only outside the can body moving route R1, it is preferable to provide the second annular member 60 outside the can body moving route R1.

In addition, in the case where the first annular member 50 is provided only inside the can body moving route R1, it is preferable to provide the second annular member 60 inside the can body moving route R1.

Moreover, other than the above, it may be possible that one of the annular members, the first annular member 50 and the second annular member 60, is provided on one of the inside and the outside of the can body moving route R1, and the other one of the annular members, the first annular member 50 and the second annular member 60, is provided on the other one of the inside and the outside of the can body moving route R1.

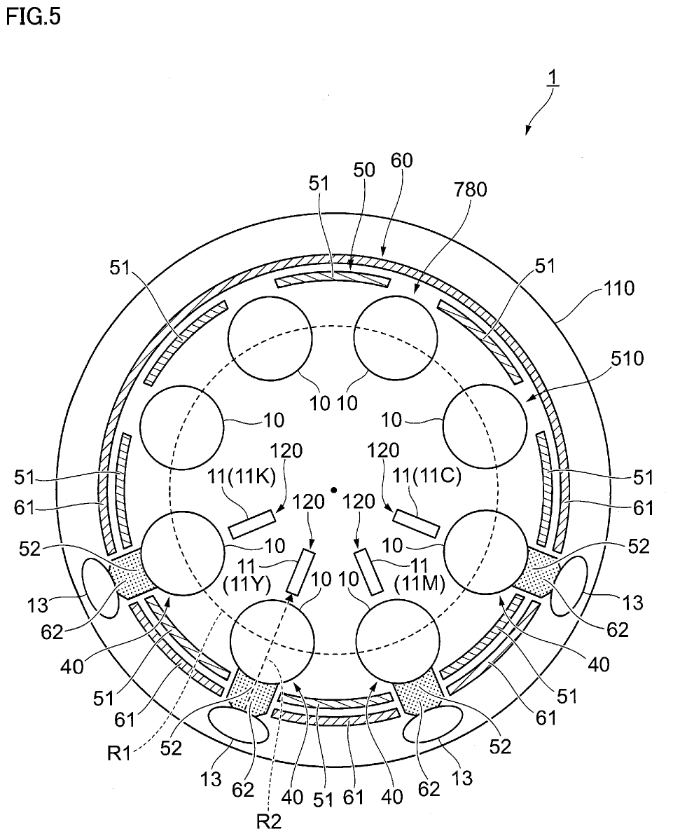

FIG. 5 is a diagram showing another configuration example of the printing device 1.

In the above, the description has been given of the case, in which the printing parts 120 are provided outside the can body moving route R1, and the light sources 13 are provided inside the can body moving route R1, as an example.

Not limited to this, the printing parts 120 may be provided inside the can body moving route R1, and the light sources 13 may be provided outside the can body moving route R1, as shown in FIG. 5.

Note that, in this configuration example, the number of printing parts 120 installed is 4. In addition, in the configuration example, positions of the can body supply part 510 and the detachment part 780 are different from the positions shown in FIG. 1.

Further, in the configuration example, the first annular member 50 and the second annular member 60 are provided outside the can body moving route R1.

In this configuration example, similar to the above, in the case where the can body 10 is not located at the stop point 40, the shielding part 51 is located on the route R2, through which the ultraviolet light from the light source 13 to proceed toward the printing part 120 passes.

More specifically, similar to the above, in the case where the can body 10 is not located at the stop point 40, the shielding part 51 configured with a part of the first annular member 50 is located at the position facing the light source 13. In other words, the shielding part 51 is located between the light source 13 and the printing part 120. This prevents the ultraviolet light from the light source 13 from reaching the printing part 120.

In addition, similar to the above, also in the configuration example, in the case where the can body 10 is located at the stop point 40, the shielding part 51 is located at the point deviated from the position facing the light source 13. In other words, in the case where the can body 10 is located at the stop point 40, the shielding part 51 is located at a point deviated from the route R2, through which the ultraviolet light from the light source 13 to proceed toward the can body 10 passes. In other words, in the case where the can body 10 is located at the stop point 40, the shielding part 51 is located at a point deviated from between the light source 13 and the printing part 120.

This irradiates the can body 10 with the ultraviolet light from the light source 13 in the case where the can body 10 is located at the stop point 40.

Further, also in the configuration example, similar to the above, in the case where the can body 10 is not located at the stop point 40, the ultraviolet light from the light source 13 passes through the passing part 52 located at the point deviated from between the light source 13 and the printing part 120, and is going to proceed toward a side opposite to the side where the light source 13 is installed. More specifically, the ultraviolet light is going to proceed toward the inside of the first annular member 50.

In contrast thereto, also in the configuration example, the restriction part 61 configured with the second annular member 60 is located at the position facing the passing part 52, and thereby the ultraviolet light from the light source 13 is prevented from passing through the passing part 52 and proceeding toward the side opposite to the side where the light source 13 is installed.

In addition, also in the configuration example, the passing parts 62 are provided at the portions of the second annular member 60, which are positioned at the points facing the stop points 40. Consequently, the ultraviolet light from the light source 13 proceeding toward the can body 10 located at the stop point 40 is prevented from being shielded by the second annular member 60.

Note that, in the configuration example shown in FIG. 5, the first annular member 50 is not limited to be provided outside the can body moving route R1, but may be provided inside the can body moving route R1 to cause the shielding parts 51 configured with part of the first annular member 50 to be disposed at the positions facing the printing parts 120.

In addition, it may be possible that the first annular members 50 are provided both inside and outside the can body moving route R1 and the shielding parts 51 configured with part of the first annular member 50 are located at both the positions facing the light sources 13 and the positions facing the printing parts 120.

Note that, in the case where the first annular members 50 are provided both inside and outside the can body moving route R1, the second annular members 60 may be provided both inside and outside the can body moving route R1, or may be provided only on one of the inside and the outside.

Note that, more preferably, similar to the above, in the case where the first annular member 50 is provided only outside the can body moving route R1, it is preferable to provide the second annular member 60 outside the can body moving route R1.

In addition, in the case where the first annular member 50 is provided only inside the can body moving route R1, it is preferable to provide the second annular member 60 inside the can body moving route R1.

Moreover, similar to the above, it may be possible that one of the annular members, the first annular member 50 and the second annular member 60, is provided on one of the inside and the outside of the can body moving route R1, and the other one of the annular members, the first annular member 50 and the second annular member 60, is provided on the other one of the inside and the outside of the can body moving route R1.

(Others)

In the configuration examples shown in the above FIGS. 1 to 5, the case providing the light source 13 emitting the ultraviolet light, as an example of a curing unit, has been described as an example; however, other than this, a heat source may be provided as the curing unit. More specifically, a heat source may be provided instead of the above-described light source 13.

More specifically, the printing part 120 may use thermosetting ink, and, in this case, a heat source is provided as the curing unit.

In this case, also, adoption of configurations shown in FIGS. 1 to 5 reduces heat from the heat source to the printing part 120; accordingly, defects such as ink curing in the printing part 120 caused by heat are less likely to occur.

In addition, in the above, the case providing the inkjet heads 11 as the printing part 120 has been described as an example; however, the printing method performed by the printing part 120 is not particularly limited, and, for example, a printing mechanism performing printing by the plate printing method may be provided as the printing part 120.

Moreover, in the configuration examples shown in FIGS. 1 to 5, the configuration providing the first annular member 50 inside the second annular member 60 has been described as an example; however, the second annular member 60 may be provided inside the first annular member 50.

In addition, in the configuration examples shown in FIGS. 1 to 5, the shielding parts 51 have been configured using part of the first annular member 50; however, not limited thereto, a shatter-shaped shielding part 51 may be individually provided at a position facing each of the light sources 13 or the printing parts 120.

In this case, the shutter-shaped shielding part 51 is opened and closed in accordance with the presence or absence of the can body 10 at the stop point 40.

In addition, in the above, there was a configuration in which a single second annular member 60 was used to provide plural restriction parts 61; however, not limited thereto, a restriction member for restricting transfer of ultraviolet light or heat may be provided to individually correspond to each of the passing parts 52 in the first annular member 50.

Moreover, in the above, the case in which the can body 10 moved along the annular can body moving route R1 was described, but each configuration described above can also be applied to a printing device 1 in which the can body 10 moves linearly.

In addition, in each configuration example described in FIGS. 1 to 3 and 5, the passing part 52 in the first annular member 50 may be provided with a reflection member such as a lens passing the light from the light source 13 and a mirror reflecting the light from the light source 13 toward the can body 10.

This makes it possible to direct the light from the light source 13 that proceeds toward somewhere other than the outer circumferential surface 10A of the can body 10 to the outer circumferential surface 10A, and thereby makes it possible to accelerate curing of the print image formed on the can body 10, as compared to the case not provided with a lens or a mirror.

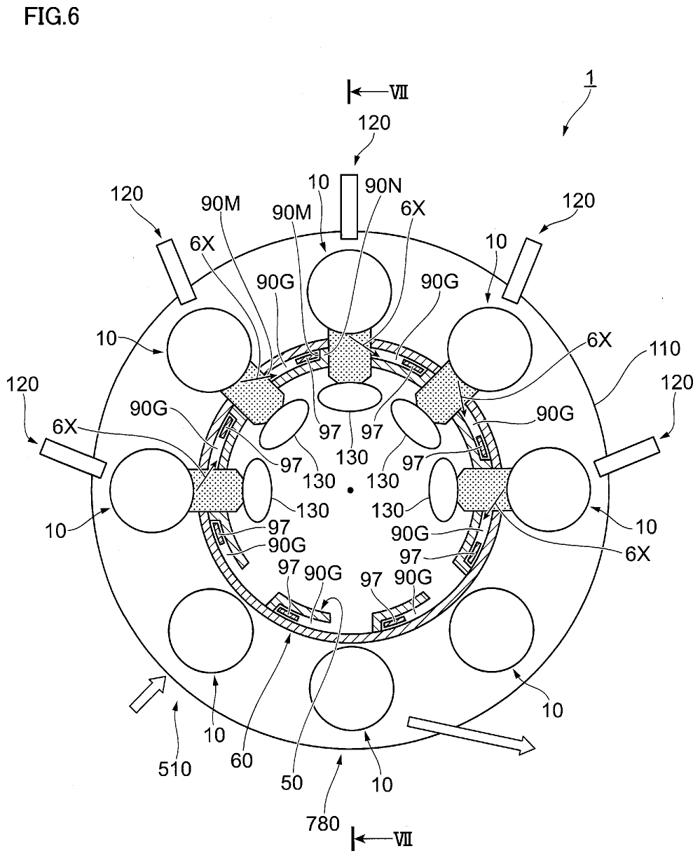

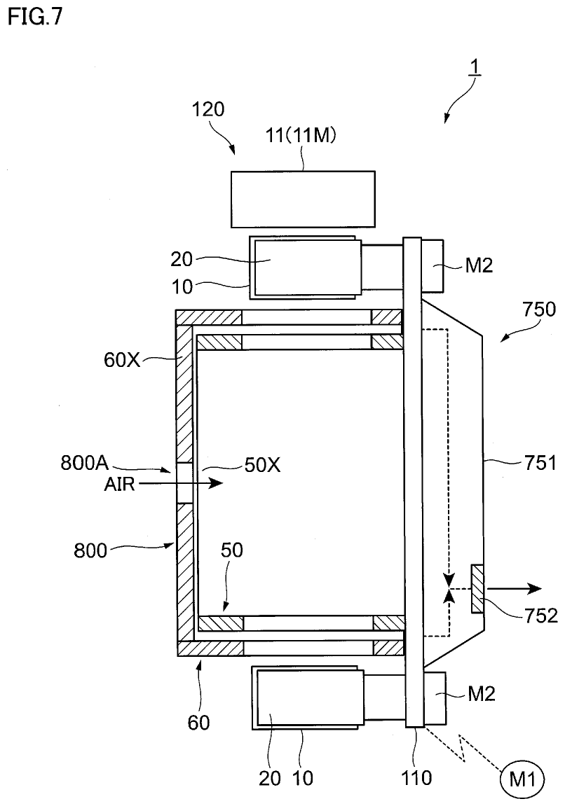

FIGS. 6 and 7 are diagrams showing other configuration examples of the printing device 1. FIG. 7 shows a cross-sectional view along the VII-VII line in FIG. 6. In addition,

FIG. 6 shows a case in which a heat source 130 is provided in place of the above-described light source 13 as an example. Moreover, in FIG. 7, illustration of the heat source 130 is omitted.

In the configuration example, as shown in FIG. 6, plural gaps 90G extending in the circumferential direction of the first annular member 50 are provided between the first annular member 50 and the second annular member 60.

Furthermore, in the configuration example, a closing part 90N is provided to correspond to each of the gaps 90G, the closing part 90N closing one of two openings 90M of the gap 90G. The closing part 90N is supported by the first annular member 50.

Further, in the configuration example, as shown in FIG. 7, there is provided a circular-disk-shaped closing member 800 that closes an opening 50X located at an end portion the first annular member 50 and an opening 60X located at an end portion the second annular member 60.

The closing member 800 is attached to the second annular member 60. In addition, the closing member 800 is provided with an air intake port 800A for taking in the air outside the second annular member 60 into the inside of the second annular member 60.

Further, as shown in FIG. 6, at a portion of the rotation member 110 that faces each of the gaps 90G, a through hole 97 is formed. Furthermore, as shown in FIG. 7, on a side opposite to the side, across the rotation member 100, where the gap 90G (refer to FIG. 6) is provided, a suction mechanism 750 that sucks the air inside the gap 90G via the through hole 97 (refer to FIG. 6) is installed.

The suction mechanism 750 is provided with a fan (not shown), a housing 751 that houses the fan, and a filter 752 that allows the air to be discharged from the housing 751 (the air drawn out of the gap 90G) to pass through.

In the case where the print image is cured by using the heat source 130 as in the exemplary embodiment, gases such as solvents and water vapors are generated from the print image, and the gases accumulate in the first annular member 50 and the second annular member 60.

On the other hand, in the exemplary embodiment, the suction mechanism 750 is provided as described above; accordingly, the gases in the first annular member 50 and the second annular member 60 are discharged through the through hole 97 to the outside of the first annular member 50 and the second annular member 60.

More specifically, in the exemplary embodiment, the gases generated from the print image enter inside the gap 90G from a position facing each can body 10, as indicated by the arrow 6X in FIG. 6. The gases are then discharged via the through hole 97 to the outside of the first annular member 50 and the second annular member 60. In other words, in the exemplary embodiment, due to the heat applied to the print image, the gases generated from the print image are discharged to the outside of the printing device 1 through the gaps 90G and the through holes 97.

Note that, at this time, the gases pass through the filter 752 provided in the suction mechanism 750.

In the case where the gaps 90G are provided as in the exemplary embodiment, the gases near the surface of the can body 10 can be discharged to the outside of the first annular member 50 and the second annular member 60 more efficiently, as compared to the case where the gases inside the first annular member 50 and the second annular member 60 are discharged without the gaps 90G.

Note that, in this example, the case in which the first annular member 50 is provided inside the second annular member 60 and the gaps 90G are provided between the first annular member 50 and the second annular member 60 was described; however, not limited thereto, the second annular member 60 may be provided inside the first annular member 50, and then the gaps 90G may be provided between the first annular member 50 and the second annular member 60.

In addition, as shown in FIG. 4, also in the case where the first annular member 50 and the second annular member 60 are provided outside the can body moving route R1, the gaps 90G may be formed, and the gases inside the first annular member 50 and the second annular member 60 may be discharged through the gaps 90G in a similar manner.

Reference Signs List
1 Printing device
10 Can body
13 Light source
30 Center
40 Stop point
50 First annular member
51 Shielding part
52 Passing part
60 Second annular member
61 Restriction part
62 Passing part
90G Gap
100 Can body moving mechanism
120 Printing part
R1 Can body moving route

1. A printing device comprising:
a can body moving unit moving a can body and stopping the can body at a stop point;
a printing part performing printing on the can body located at the stop point to form a print image on the can body;
a curing unit disposed on a side opposite to a side on which the printing part is installed across a can body moving route, which is a moving route of the can body, the curing unit emitting light or heat to the can body located on the stop point to cure the print image formed on the can body; and
a shielding part located between the curing unit and the printing part, when the can body is not located at the stop point, to shield light or heat proceeding from the curing unit toward the printing part.

2. The printing device according to claim 1, wherein, when the can body is not located at the stop point, the shielding part is located at a point facing at least one of the curing unit and the printing part, and, when the can body is located at the stop point, the shielding part is located at a point deviated from the facing point.

3. The printing device according to claim 1, wherein
the can body moving unit moves the can body to move around a predetermined center, and
the curing unit is disposed closer to the center than the can body moving route through which the moving can body passes.

4. The printing device according to claim 3, wherein the shielding part is disposed closer to the center than the can body moving route.

5. The printing device according to claim 1, wherein
the can body moving unit moves the can body to move around a predetermined center, and
the shielding part is configured with part of an annular member formed into an annular shape and rotating around a point where the center is positioned as a rotation center.

6. The printing device according to claim 1, wherein
the can body moving unit moves the can body to move around a predetermined center,
the shielding part is configured with part of an annular member formed into an annular shape and rotating around a point where the center is positioned as a rotation center,
the annular member is provided with a passing part for passing the heat or the light proceeding from the curing unit toward the can body, and,
when the can body is located at the stop point, the passing part of the annular member is located between the curing unit and the can body to allow light or heat from the curing unit to pass through the passing part and proceed toward the can body.

7. The printing device according to claim 6, wherein the annular member rotates while keeping a state in which the passing part provided in the annular member is located at a position facing the can body.

8. The printing device according to claim 6, wherein the passing part of the annular member is provided with at least one of a lens passing light proceeding from the curing unit toward the can body and a reflection member reflecting light from the curing unit toward the can body.

9. The printing device according to claim 6, wherein,
when the can body is not located at the stop point, the passing part of the annular member is located at a point deviated from between the curing unit and the printing part, and
a restriction part is further provided to restrict light or heat from the curing unit that passes the passing part located at the deviated point and proceeds toward a side opposite to a side on which the curing unit is provided.

10. The printing device according to claim 9, wherein the restriction part is configured with part of an annular-shaped member disposed coaxially with the annular member.

11. The printing device according to claim 10, wherein the annular-shaped member is provided with a passing part for passing the heat or the light proceeding from the curing unit toward the can body located at the stop point.

12. The printing device according to claim 10, wherein
a gap is formed between the annular member and the annular-shaped member disposed coaxially with the annular member, and
gas generated from the print image due to heat applied to the print image passes through the gap, and is discharged to outside of the printing device.
